(19) United States
(12) Patent Application Publication
(10) Pub. No.: US 2026/0224077 A1
(43) Pub. Date: Aug. 6, 2026

(54) MULTI-USE VACUUM CLEANER

(71) Applicant: SENUR ELEKTRIK MOTORLARI SAN. VE TIC. A.S., Istanbul (TR)

(72) Inventors: Fahrettin GUZELTEPE, Istanbul (TR); Yasemin ULUKAN, Istanbul (TR); Yavuz BICER, Istanbul (TR)

(73) Assignee: SENUR ELEKTRIK MOTORLARI SAN. VE TIC. A.S., Istanbul (TR)

(21) Appl. No.: 19/152,871

(22) PCT Filed: Jan. 31, 2024
(86) PCT No.: PCT/TR2024/050078

§ 371 Date: Jul. 31, 2025

(30) Foreign Application Priority Data
Feb. 1, 2023 (TR) 2023/001152

(51) Int. Cl. A47L 5/22; A47L 9/12; A47L 9/16; A47L 9/28; B04C 5/02; B04C 5/26; B04C 9/00

(52) U.S. Cl. CPC A47L 5/225; A47L 9/12; A47L 9/1625; A47L 9/165; A47L 9/1683; A47L 9/1691; A47L 9/2884; B04C 5/02; B04C 5/26; B04C 9/00; B04C 2009/002; B04C 2009/005

(57) ABSTRACT

The present invention relates to a vacuum cleaner comprising: a main body to which a vacuum cleaner hose can be attached and which has movable rollers; and a suction unit having a motor for drawing air, a filter for filtering the drawn air and at least one battery. The vacuum cleaner further comprises a placement housing in the main body arranged for placing the suction unit; the suction unit which, according to the user's desire, can be utilized in a vertical position in which it is removed from the main body, or in a horizontal position in which it is placed in the placement housing in the main body; and an air inlet channel formed in the main body in such a way that a suction end of the suction unit can be received therein.

### TECHNICAL FIELD OF THE INVENTION

The present invention relates to a vacuum cleaner to be used in multiple different positions.

### BACKGROUND OF THE INVENTION

In the prior art, rechargeable vacuum cleaners are operated to remove the dirt on the surface by means of a vacuum created by the motor that is driven by a battery assembly. Rechargeable vacuum cleaners comprise a floor brush that cleans the floor by suctioning, a pipe attached to the floor brush, and a vacuum cleaner body at the other end of the pipe. The vacuum cleaner body has a grip handle, a motor, a dust reservoir, a battery assembly, and related electronics therein.

In the prior art, the existing vertical rechargeable vacuum cleaners (i.e., cordless Stick Vacuum cleaners) comprise a vacuum cleaner body immediately after the floor brush, a pipe attached to the vacuum cleaner body, and a grip handle at the other end of the pipe. In this type of rechargeable vacuum cleaners that require a battery, when the battery runs out, it is necessary to either connect a charging adapter to the vacuum cleaner, or to place the vacuum cleaner or the battery of the vacuum cleaner in the charging station where the charging adapter is connected.

Conventional horizontal vacuum cleaners comprise a floor brush that removes dust from the floor, an extension pipe connected thereto, a grip handle positioned on the pipe, a hose assembly attached to the end of the handle, and a main body to which the hose assembly is connected and which contains a dust reservoir and an electric motor. In conventional horizontal rechargeable vacuum cleaners, the main body including the dust reservoir and the motor is moved on rollers. While the user is cleaning-up with a vacuum cleaner, the main body having a roller structure moves with the user. In horizontal vacuum cleaners of the usual kind, the electric motor that creates suction to collect dust is energized by an electric cable attached to the main power line. In this type of conventional electric horizontal vacuum cleaners, the length of the power cable determines the extension of the cleaning area. Rechargeable vacuum cleaners have unlimited mobility since they are powered by an internal battery assembly rather than an electric cable connected to the wall. With the grip handle located on the main body containing the dust reservoir, the motor and the battery assembly, it is possible to suction the dirt from the floor by attaching the pipe and the floor brush on the main body, or directly on the dirt by attaching small accessories on the main body.

An advantage of rechargeable vacuum cleaners is that they allow the user to clean the desired area without requiring a continuous electrical connection, thanks to the battery assembly contained therein. On the other hand, in the existing rechargeable vacuum cleaner embodiments, the user must constantly carry the weight of the motor, the reservoir, and the battery assembly while cleaning-up. Although this is not a problem for a short period of time for cleaning, it is very tiring for the user to carry the weight of the main body constantly for a long cleaning-up process. Since the main body, which contains the main weight elements in the conventional horizontal vacuum cleaners, is moved on the rollers, the user does not carry the heavy components such as the motor.

However, in conventional horizontal vacuum cleaners, since the motor is powered by the electric cable connected to the main power line of the house, the length of the electric cable determines the width of the cleaning area. The user cannot reach those places where the length of the cable is not sufficient. When it is desired to move forward during use, since the cable is connected to the socket, it makes it hard to move, which is thus restrictive.

In short, rechargeable vacuum cleaners are tiring because the weight is held by hand, whereas horizontal vacuum cleaners are restrictive because they require an electrical connection.

### OBJECTS OF THE INVENTION

An object of the present invention is to provide a vacuum cleaner to be used in multiple different positions, which prevents the aforementioned disadvantages.

Another object of the present invention is to provide a vacuum cleaner enabling a suction unit which enables a suction unit suitable for upright use to be used in a reclined position.

Another object of the present invention is to provide a vacuum cleaner that can be used easily and comfortably in a horizontal position by moving the suction unit, which contains such structures as the motor and the battery, being the weight elements, on a main unit provided with the rollers, and by means of the main body connected to the vacuum cleaner hose.

Another object of the present invention is to provide a vacuum cleaner which has a long service life due to the fact that both the battery in the main body and in the suction unit are charged at the same time.

Another object of the present invention is to provide a vacuum cleaner in which the dust is filtered twice by means of a cyclone structure.

Another object of the present invention is to provide a vacuum cleaner which offers a longer service life given that the dust suctioned is filtered both in the main body and in the suction unit.

Still another object of the present invention is to provide a vacuum cleaner system which can be used by the user, if desired, in a vertical position with or without a hose, or in a horizontal position on the main body.

### SUMMARY OF THE INVENTION

The present invention relates to a vacuum cleaner comprising: a main body to which a vacuum cleaner hose can be attached and which has movable rollers; and a suction unit having a motor for drawing air, a filter for filtering the drawn air, and at least one battery. The vacuum cleaner further comprises a placement housing in the main body arranged for placing the suction unit; the suction unit which, according to the user's desire, can be utilized in a vertical position in which it is removed from the main body, or in a horizontal position in which it is placed in the placement housing in the main body; and an air inlet channel formed in the main body in such a way that a suction end of the suction unit can be received therein.

### BRIEF DESCRIPTION OF THE DRAWINGS

The vacuum cleaner of the present invention is shown in the accompanying drawings for better understanding thereof, which are merely included to better illustrate the present invention and are not intended to limit the invention.

FIG. 1a is a perspective view of a first type embodiment of a vacuum cleaner having a first type cyclone and an inclined surface on which the suction unit is to be placed.

FIG. 1b is a perspective view of the first type vacuum cleaner in FIG. 1a from a different angle.

FIG. 2 is an exploded view of the first type vacuum cleaner in FIG. 1a.

FIG. 3a is a cross-sectional view of the first type vacuum cleaner of the present invention.

FIG. 3b is a view of the first type vacuum cleaner in FIG. 3a, with the first type cyclone removed.

FIG. 3c is a perspective view of the first type vacuum cleaner, with the cyclone removed.

FIG. 4a is a side view of a second type embodiment of the vacuum cleaner having the cyclone and a flat surface on which suction unit is to be placed.

FIG. 4b is a cross-sectional view of the second type vacuum cleaner in FIG. 4a.

FIG. 4c is an exploded perspective view of the second type vacuum cleaner.

FIG. 5a is a side view of the second type vacuum cleaner in FIG. 4c.

FIG. 5b is a cross-sectional view of the second type vacuum cleaner in FIG. 5a.

FIG. 6a is a side view of a third type embodiment of the vacuum cleaner having a cyclone and a placement housing in which the suction unit is to be placed vertically.

FIG. 6b is a perspective view of the third type embodiment of the vacuum cleaner having a cyclone and a placement housing in which the suction unit is to be placed vertically.

FIG. 6c is a perspective view of the third type vacuum cleaner, with the suction unit removed.

FIG. 6d is a cross-sectional view of the third type vacuum cleaner.

FIG. 7a is a perspective view of a fourth type embodiment of a vacuum cleaner without a further reservoir.

FIG. 7b is a cross-sectional view of the fourth type vacuum cleaner in FIG. 7a.

FIG. 8 is a perspective view of the fourth type vacuum cleaner, with the suction unit removed.

FIG. 9a is an exploded view of the fourth type vacuum cleaner.

FIG. 9b is a cross-sectional view of the fourth type vacuum cleaner in FIG. 9a.

FIG. 10a is a perspective view of a fifth type version of the vacuum cleaner having a second type cyclone.

FIG. 10b is an exploded view of the fifth type vacuum cleaner.

FIG. 11a is a cross-sectional view of the fifth type vacuum cleaner in FIG. 10a.

FIG. 11b is a view of the fifth type vacuum cleaner shown in cross-section in FIG. 11a, with the second type cyclone removed.

FIG. 12 is a perspective view of the suction unit according to the present invention, illustrating the vertical use thereof with the hose attached.

FIG. 13 is a side view of the vacuum cleaner of the present invention, illustrating its use in combination with a vacuum cleaner hose and a floor brush.

FIG. 14a is an exploded perspective view of the sixth type version of a vacuum cleaner having a main body containing a dust bag.

FIG. 14b is a perspective view of the sixth type embodiment having a dust bag, with the dust bag placed inside the main body and the suction unit removed.

FIG. 14c is a perspective view of the sixth type embodiment in FIG. 14a, with the suction unit removed and the dust bag covered with a cover.

FIG. 15 is a perspective view of the seventh type version of a main body of a vacuum cleaner.

FIG. 16a is a cross-sectional view of the main body and a suction unit of the seventh type version of the vacuum cleaner, in which the main body is removed.

FIG. 16b is a cross-sectional view of the vacuum cleaner shown in FIG. 16a, in which the suction unit is placed.

FIG. 17 is a perspective view of the suction unit for use in the seventh type version of the vacuum cleaner.

FIG. 18a is a perspective view of a grip handle of the suction unit shown in FIG. 17.

FIG. 18b is another perspective view of the grip handle of the suction unit shown in FIG. 17.

FIG. 19a is a perspective view of a blockage member for use in the seventh type version of the vacuum cleaner.

FIG. 19b is another perspective view of the blockage member for use in the seventh type version of the vacuum cleaner.

### DETAILED DESCRIPTION OF THE INVENTION

The invention will now be explained in detail with reference to the drawings attached to the description, wherein the list of part numbers used in the drawings is as follows;

| | |
|---|---|
| 10. Main body | 30. First type cyclone |
| 11. Placement housing | 31. Reservoir |
| 12. Air inlet channel | 32. First cyclone zone |
| 13. First type cyclone housing | 321. Second cyclone zone |
| 131. Second type cyclone housing | 33. Air inlet nozzle |
| 14. Battery housing | 34. Bottom cover |
| 15. Roller | 40. Second type cyclone |
| 151. Auxiliary roller | 41. Reservoir |
| 16. Charge connector | 42. Reservoir handle |
| 161. Opposing Charge connector | 43. Cyclone air inlet opening |
| 17. Main body inlet port | 44. Ramp |
| 18. Latch | 45. Monocyclone suction duct |
| 20. Suction unit | 46. Cyclone air outlet opening |
| 21. Battery section | 47. Upper cover |
| 22. Battery | 50. Adaptor |
| 221. Auxiliary battery | 51. Adaptor end |
| 23. Suction end | 60. Dust bag |
| 24. Grip handle | 52. Adaptor housing |
| 241. Engagement hole | 61. Dust inlet nozzle |
| 25. Vacuum cleaner hose | 62. Dust bag cover |
| 251. Holding area | 70. Blocking member |
| 26. Hose extension | 71. Engagement tip |
| 27. Floor brush | 72. Abutment protrusion |
| | 73. Support member |
| | X. Longitudinal axis of the main |
| | body |
| | 100. Vacuum cleaner |

The present invention relates to a vacuum cleaner (100) comprising a main body (10) to which a vacuum cleaner hose (25) can be connected and having movable rollers (15), a suction unit (20) comprising a motor for drawing air, a filter for filtering the drawn air, and at least one battery (22). Said vacuum cleaner (100) comprises a placement housing (11) in the main body (10) suitable for placing the suction unit (20); the suction unit (20) which, according to the user's desire, can be used in a vertical position in which it is removed from the main body (10), or in a horizontal position in which it is inserted into the placement housing (11) in the main body (10), and a suction end (23) of the suction unit (20), to which the vacuum cleaner hose (25), more particularly a hose extension (26) can be attached, according to the user's desire, when it is in the vertical position; and an air inlet channel (12) located in the main body (10) in such a way that the suction end (23) of the suction unit (20) can be received therein, allowing the air drawn into the vacuum cleaner (100) to be passed into the suction unit (20).

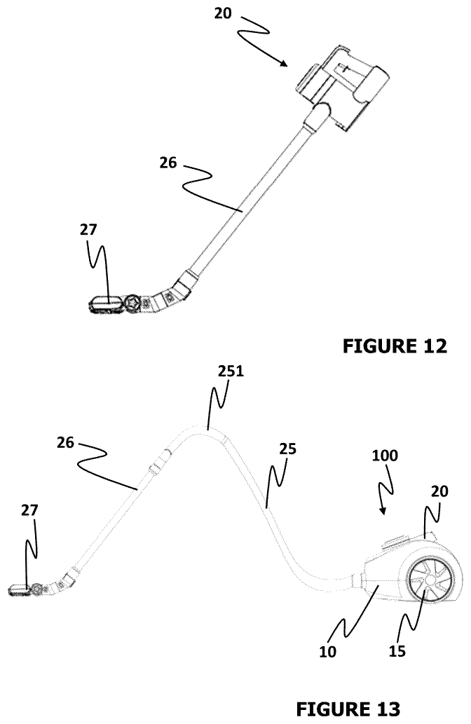

The vacuum cleaner (100) of the present invention allows multiple use and can be used in a horizontal position in which the suction unit (20) is positioned on the main body (10), and in a vertical position in which the suction unit (20) is removed from the main body (10). Furthermore, the suction unit (20) can be used in two different ways, both with and without the hose extension (26) attached as can be seen in FIG. 12.

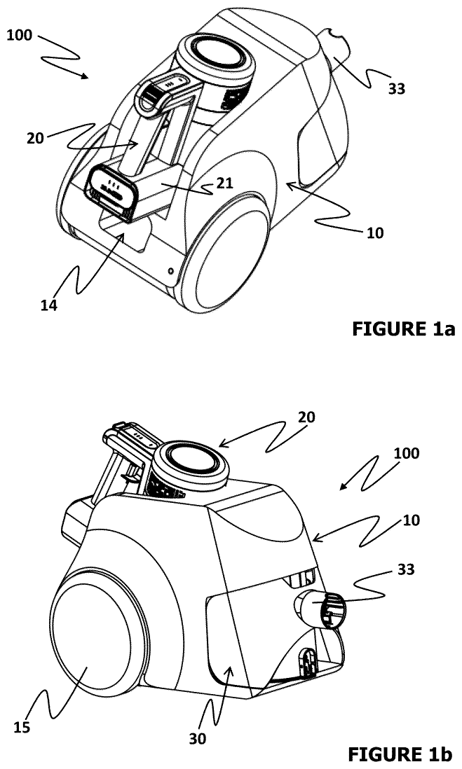

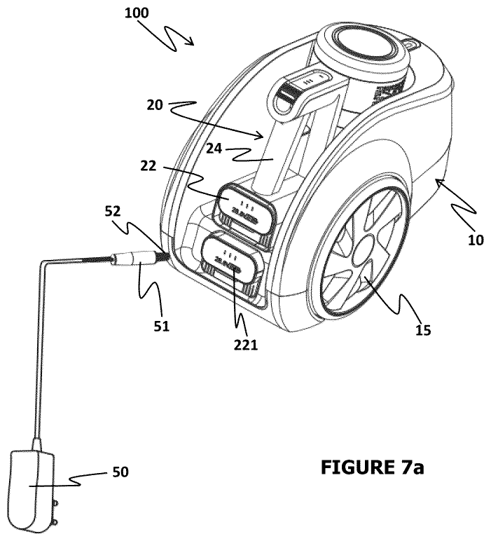

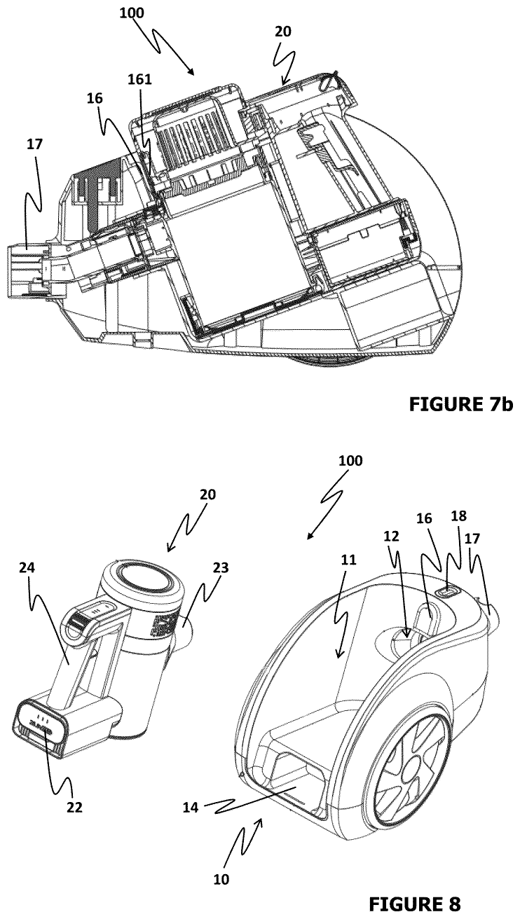

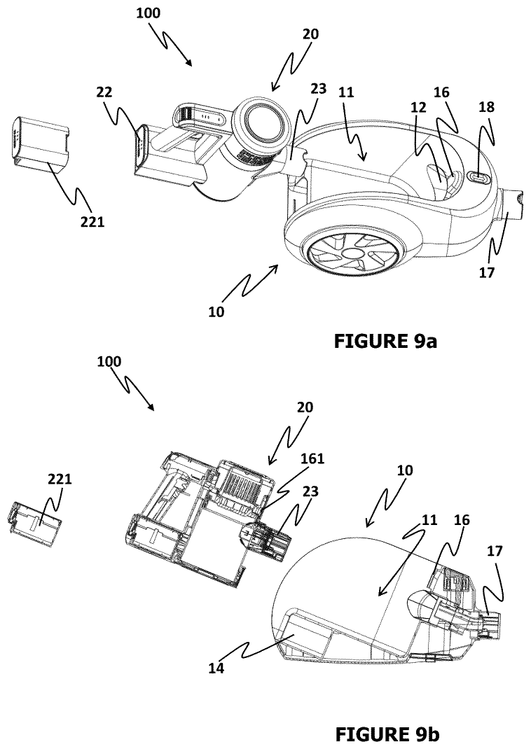

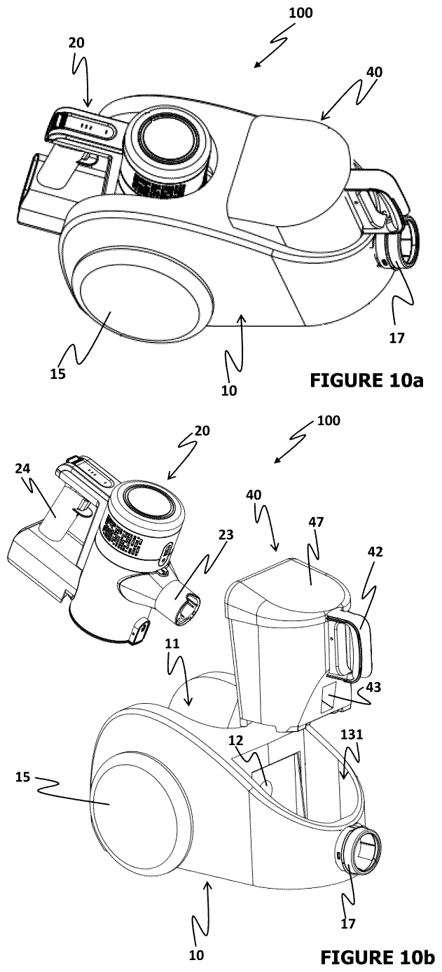

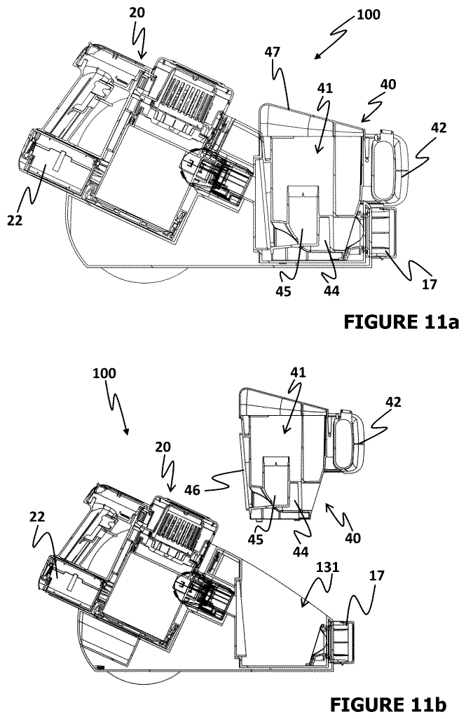

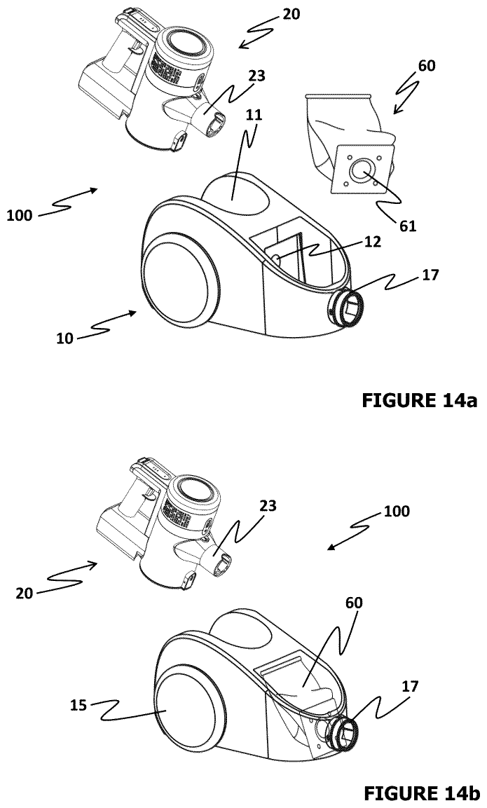

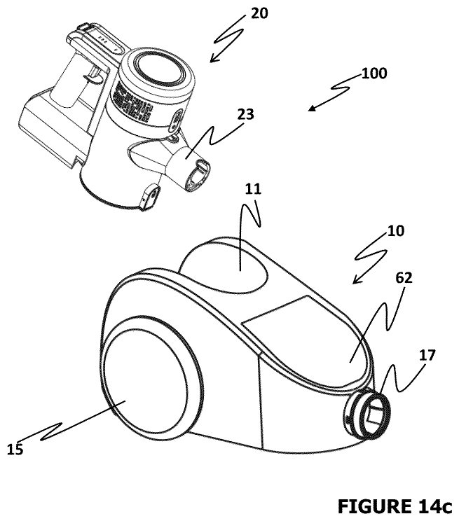

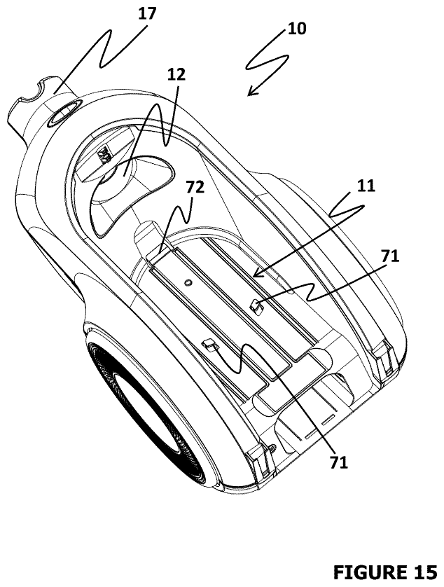

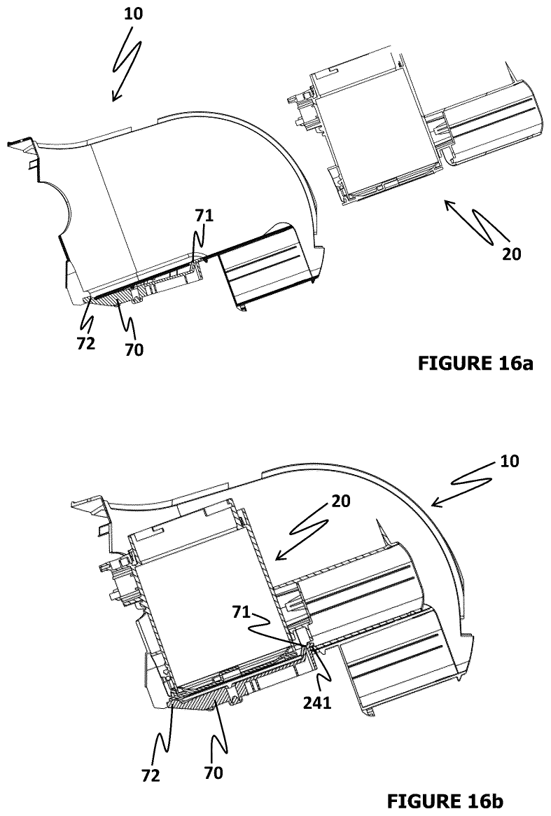

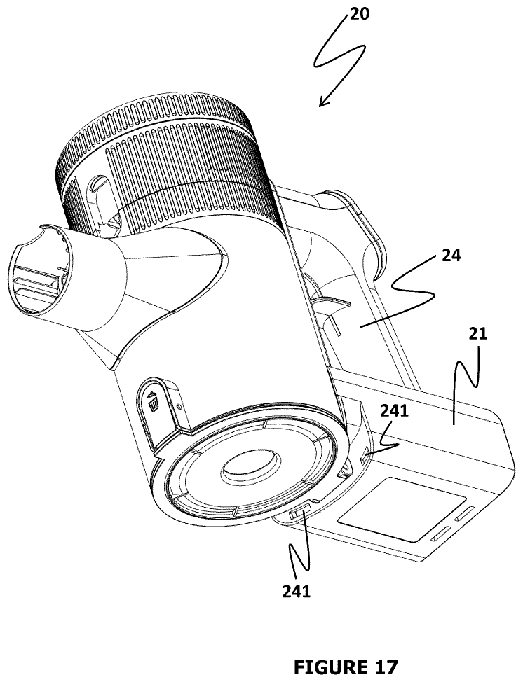

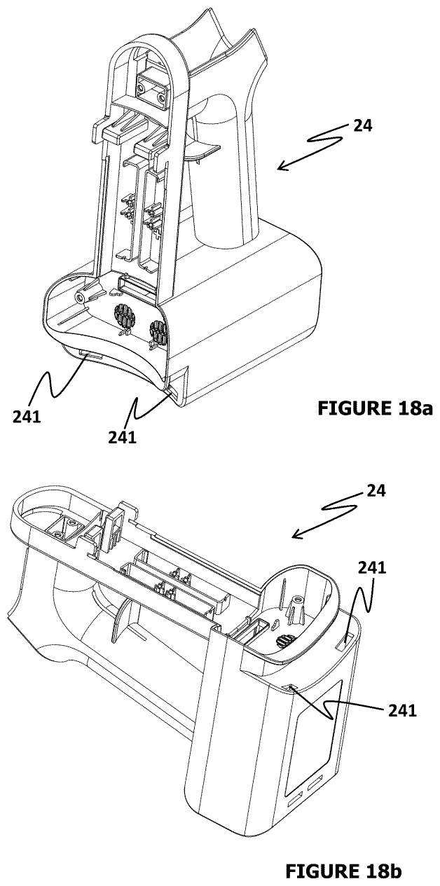

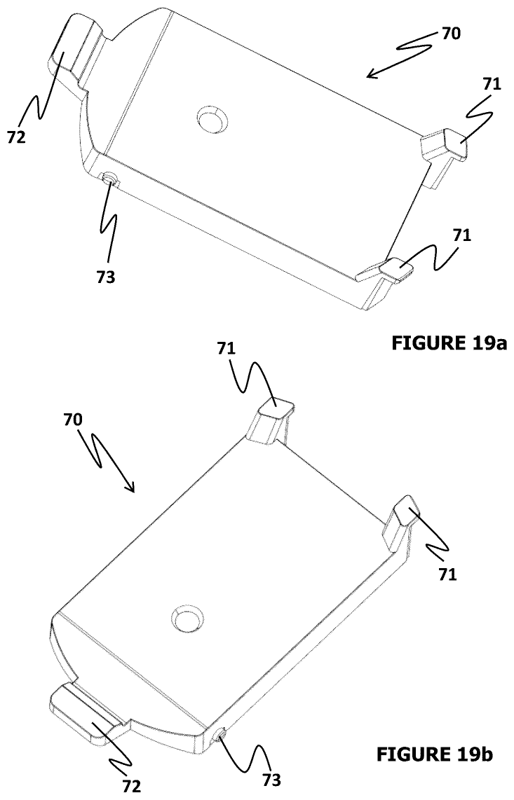

The vacuum cleaner (100) can have 7 different types of embodiments as supported by the present drawings. In the first three types of embodiments in FIGS. 1 to 6, the vacuum cleaner (100) comprises a first type cyclone (30) and the suction unit (20) that can be positioned in different positions. In the fourth type embodiment of the vacuum cleaner (100) in FIGS. 7 to 9, there is no separate reservoir, and the suction unit (20) is also located in the main body (10). FIGS. 10 and 11 illustrate a fifth type embodiment of the vacuum cleaner (100), wherein the vacuum cleaner (100) has a second type cyclone (40) placed in the main body (10). Within the scope of the invention, there may be different embodiments wherein the suction unit (20) is again positioned at different positions. FIGS. 14a-c, in which a non-limiting sixth type embodiment of the invention is shown, the vacuum cleaner (100) has a dust bag (60) and an inclined-bottom placement housing (11). FIGS. 16a and 19b illustrate a seventh type embodiment of the vacuum cleaner (100), wherein the main body (10) has a blocking member (70) attached under the placement housing (11) and configured to engage with the suction unit (20), so as to allow the suction unit (20) to be lifted perpendicularly with respect to the longitudinal axis of the main body (X).

In the first type embodiment of the invention, the air drawn from the floor by a floor brush (27) passes through the hose extension (26) and the vacuum cleaner hose (25) into an air inlet nozzle (33) in the first type cyclone (30). This cylindrically shaped air inlet nozzle (33) is received in the first type cyclone (30), which is designed for the separation of dust in the air. This incoming air is first rotated along the inner wall of a first cyclone zone (32) inside a reservoir (31). The air sucked in by the grids passes therefrom into a multiple second cyclone zone (321). There may be plurality of cyclone separation elements located in the second cyclone zone (321). The air is dispersed in the said cyclone separation elements and is further filtered inside each of them and drawn through a common air gap zone. The common air gap zone can also have a filter which is preferably covered with a sponge/fabric/special material and sealed. The air, which is thus filtered again, is directed into the air inlet channel (12) which opens into the placement housing (11). The air inlet channel (12) is configured in accordance with the suction end (23) of the suction unit (20) and allows the drawn air to pass from the suction end (23) into the suction unit (20).

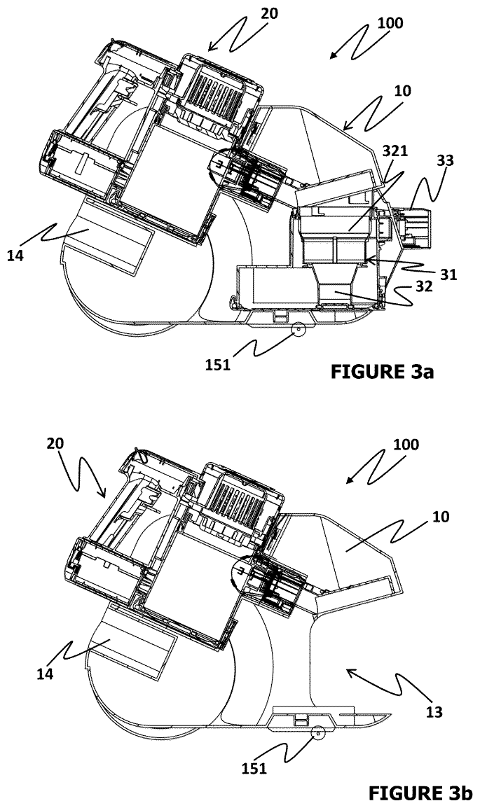

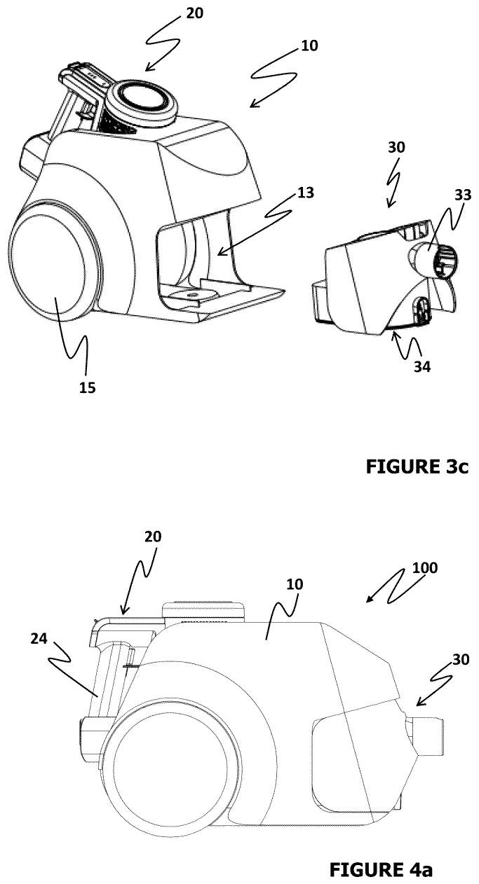

In the first type of vacuum cleaner (100), as can be seen in FIG. 1, the placement housing (11) in the main body (10) is configured to be inclined towards the ground plane. This inclination can preferably be selected to be between 10° and 40°. This allows the user to slide the suction unit (20) into the main body (10) in an easier manner and bring it into the appropriate coupling position. As can be seen in FIGS. 3a and 3b, when the suction unit (20) is seated on the main body (10), the respective suction end (23) is received into the air inlet channel (12) and allows the air from the first type cyclone (30) to be passed into the suction unit (20). In a preferred embodiment of the invention, when the suction unit (20) is positioned, there may be provided a lock for securing the suction unit (20) to the main body (10). The lock structure can be opened by pressing a latch positioned on the main body (10). The lock also ensures continuous energy transmission in the charge connectors.

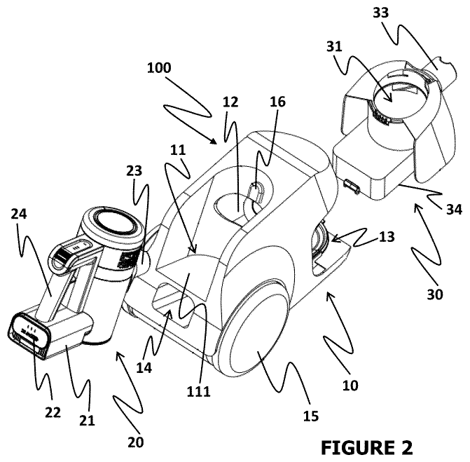

As can be seen in FIGS. 2 and 3, when the suction unit (20) is seated on the placement housing (11), an opposing charge connector (161) on the suction unit (20) contacts a charge connector (16) on the main body. Referring to FIG. 7a, the battery (22) in the suction unit (20) is thus charged when the main body (10) is supplied with an electric current via a suitable adapter (50). The suction unit (20) is preferably provided with a battery section (21) at the bottom, and the respective battery (22) can be inserted into the battery section (21). Said battery section (21) also forms the bottom part of the suction unit (20) and is configured to contact the placement housing (11).

When the suction unit (20) is locked onto the main body (10), it moves as one piece and the user can grasp a grip handle (24) in order to lift or move the vacuum cleaner (100). Referring to FIG. 2, with the suction unit (20) which is placed into the placement housing (11), the air sucked in is first received in the first type cyclone (30) and then through the first and second cyclone zones (32, 321), respectively, into the suction end (23). Thus, the air entering the vacuum cleaner (100) is further filtered in the reservoir inside the suction unit (20), is sucked by the motor and discharged.

Said first type cyclone (30) is removably attached to the first type cyclone housing (13) that is preferably formed in the lower part of the main body (10). The dust sucked from the floor is first collected in the reservoir (31) of the first type cyclone (30). The reservoir (31) is designed so that the user can pull it out. In a preferred embodiment of the invention, the first type cyclone (30) may comprise a bottom cover (34) which can be opened by means of a latch for cleaning the dust collected. The bottom cover (34), which is supported at one end, moves pivotally in a certain direction, thereby allowing the dust accumulated therein to fall out.

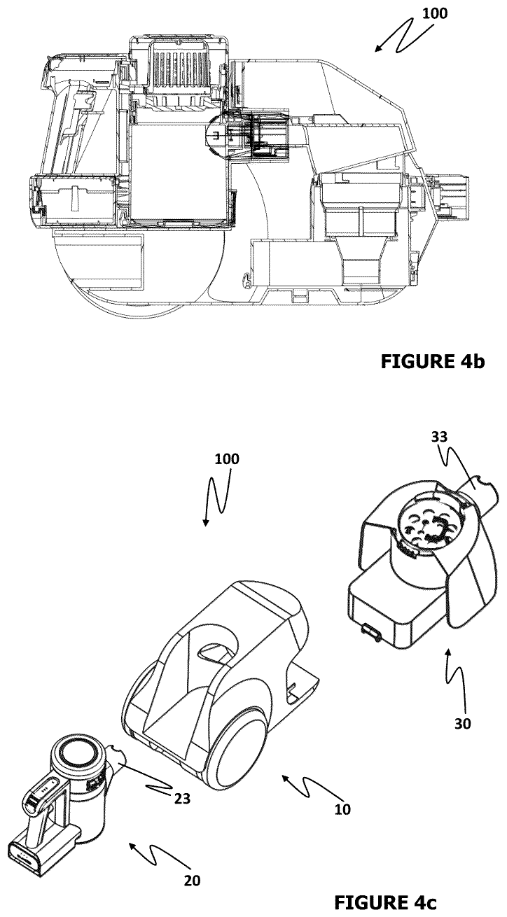

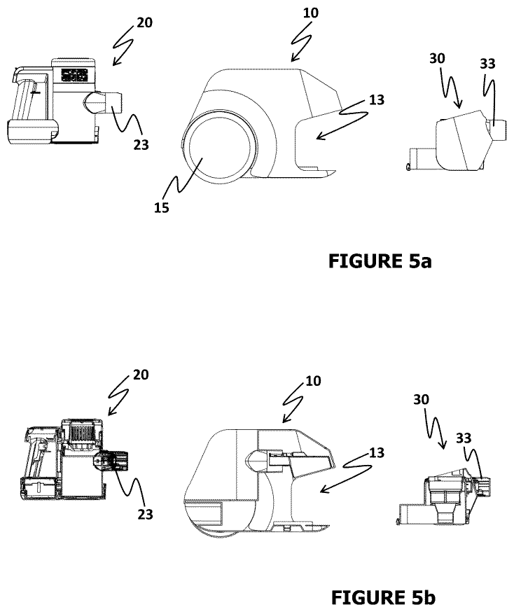

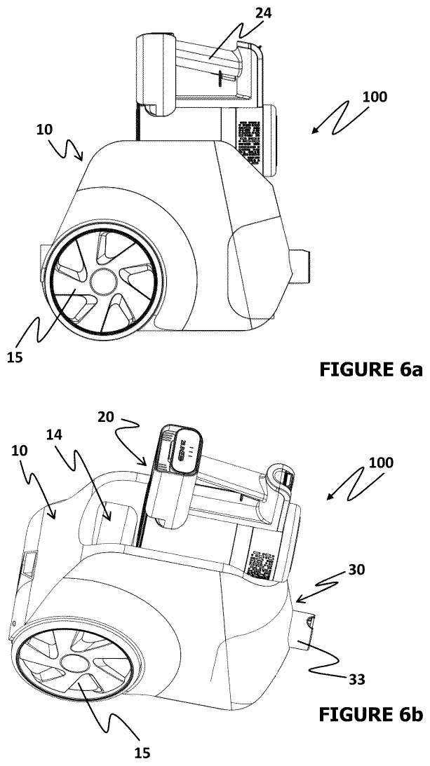

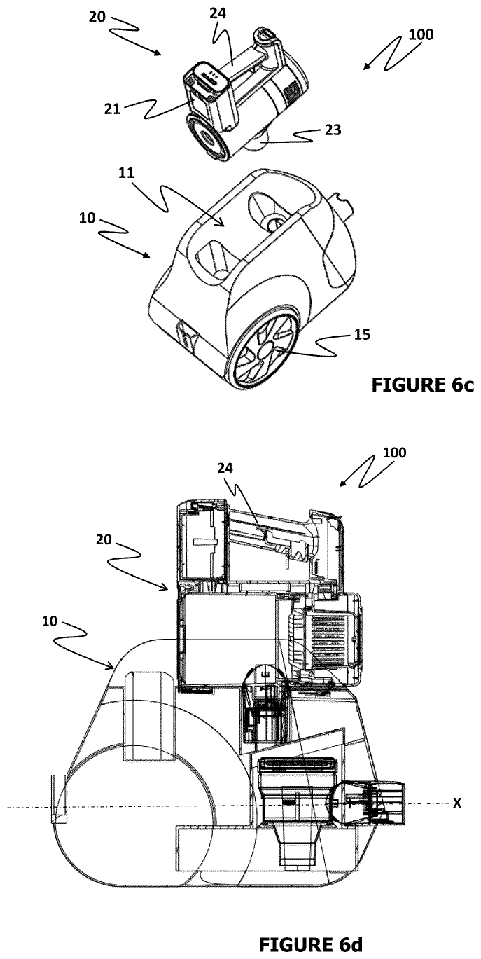

The second embodiment of the vacuum cleaner (100) of the present invention is shown in FIG. 4a to FIG. 5b, the only difference from the first embodiment being that the bottom of the placement housing (11) is configured to be parallel with the ground plane on which the vacuum cleaner (100) is to be moved, but not inclined. A third embodiment of the present invention is illustrated in FIGS. 6a to 6d, with the only difference from the first type vacuum cleaner (100) being that the suction unit (20) is arranged vertically with respect to a longitudinal axis of the main body (X). As can be seen in FIG. 6d, in this third type embodiment, the placement housing (11) is formed on the main body (10) and the suction end (23) of the suction unit (20) extends to the first type cyclone (30) in a direction perpendicular to the ground plane. This embodiment ensures that the suction unit (20) is securely held in the main body (10).

In FIGS. 7a to 9b wherein the fourth embodiment of the invention is shown, the vacuum cleaner (100) does not comprise a secondary dust filter. In this fourth embodiment of the invention, the air drawn from the floor by the floor brush (27) passes through the vacuum cleaner hose (25) and into a main body inlet port (17). This cylindrical and hollow main body air inlet port (17) opens into the air inlet channel (12) in the main body (10) and is connected to the suction end (23) in the suction unit (20). As in the first type embodiment, the placement housing (11) is inclined with respect to the longitudinal axis of the main body (X). Again, when the suction unit (20) is seated on the placement housing (11), the opposing charge connector (161) on the main suction unit (20) is contacted with the charge connector (16) on the main body (10). During such coupling, a lock structure can also be provided and the suction unit (20) can be locked. The lock structure can be opened by pressing a latch (18) positioned on the main body (10). Once locked onto the movable main body (10), the suction unit (20) moves as one piece and the user can grasp the grip handle (24) of the suction unit (20) in order to lift or move the whole system.

As can be seen in FIG. 7b, in the fourth type embodiment of the invention, the air sucked in by the suction unit (20) placed in the placement housing (11) is received into the vacuum cleaner (100) through the main body inlet port (17) and then the suction end (23). The air received in the vacuum cleaner (100) is filtered in the reservoir in the suction unit (20), and as the last step, the air sucked in by the motor is discharged.

In FIGS. 10a and 11b, where the fifth type embodiment of the invention is shown, the second type cyclone (40) is used instead of the first type cyclone (30). In this fifth type of vacuum cleaner (100), the air drawn from the floor by the floor brush (27) passes through the vacuum cleaner hose (25) and into the main body inlet port (17). The air passing through the main body air inlet port (17) is received through a cyclone air inlet opening (43) in the second type cyclone (40) designed for the separation of dust in the air. In the second type cyclone (40), the air entering through the main body inlet port (17), is passed through the cyclone air inlet opening (43), after which it rises on a ramp (44) at the bottom of a reservoir (41). While the dust and particles remain in the reservoir (41), the air passes through a mono cyclone suction duct (45), which is passed through a cyclone air outlet opening (46) into the suction end (23) which is driven into the air inlet channel (12) in the main body (10). It is also possible to provide a filter made of fabric/sponge/special material.

The suction unit (20) is attached by driving it all the way into the placement housing (11), which has a bottom which is also inclined with respect to the longitudinal axis of the main body (X). Once positioned, the opposing charge connector (161) on the suction unit (20) contacts with the charge connector (16) on the main body (10).

The suction end (23) of the suction unit (20) is received in the air inlet channel (12), as shown in FIG. 11a, and preferably a lock may be provided for securing the suction unit (20), which can be called herein as a vertical vacuum cleaner, to the movable main body (10). The lock structure can be opened by pressing a latch positioned on the main body (10). Once coupled, the suction unit (20) moves as one piece, and the user can grasp the grip handle (24) of the suction unit (20) in order to lift or carry the whole system. The lock is also required for continuous energy transmission in the charge connectors.

Referring to FIG. 11a, the air sucked in by the second type cyclone (40) placed in the second type cyclone housing (131) is first received in the mono cyclone reservoir (41), which is then passed through the ramp (44), the air mono cyclone suction duct (45) and the cyclone air outlet opening (46), respectively, and into the suction end (23), and the air entering the suction unit (20) is filtered again and sucked by the motor and discharged.

Referring to FIG. 10b, the dust sucked from the floor is first collected in the mono cyclone reservoir (41) in the second type cyclone (40). The second type cyclone (40) having the reservoir (41) is also designed so that the user can pull it out by means of a reservoir handle (42). The second type cyclone (40) can be pulled and removed from the second type cyclone housing (131) in a vertical direction relative to the ground plane. In a preferred embodiment of the invention, said second type cyclone may further have an upper cover (47) supported at one end, and opened by a user.

In the vacuum cleaner (100) of the present invention, when the suction unit (20) is placed in the placement housing (11) in the main body (10), the opposing charge connector (161) and the charge connector (16) are in contact with each other. When the main body (10) is connected to the adapter (50), the battery (22) in the suction unit (20) starts charging. In a preferred embodiment of the invention, an audible or visual warning may be provided to inform the user when the battery (22) and the backup battery (221), if provided in the main body (10), are fully charged. When the batteries (22) are fully charged, an adapter end (51) of the corresponding adapter (50) can be removed from an adapter housing (52) formed on the main body (10) to continue use.

For example, in the fourth type embodiment of the invention, the main body (10) is provided with the main body inlet port (17) to which the vacuum cleaner hose (25) can be sealingly connected. When the suction unit (20) is disposed in the main body (10) as described above, the suction end (23) is associated with the main body inlet port (17). Again, as can be seen in FIG. 13, the vacuum cleaner hose (25) is attached to the main body inlet port (17), and the hose extension (26), preferably in the form of a pipe, is provided at the other end of this vacuum cleaner hose (25). The hose extension (26), preferably with a pipe made of metal, has the floor brush (27) at its end. FIG. 12 shows a view of the suction unit (20) which is suitable for vertical use, wherein the suction end (23) can be directly connected to the hose extension (26). The user can change the floor brushes (27) to the hose extension as desired.

Referring to FIG. 13, when the vacuum cleaner (100) having the suction unit (20) is operated, the user can hold a holding area (251) on the vacuum cleaner hose (25) to perform cleaning. The main body (10) is provided with large opposing rollers (15) and at least one auxiliary roller (151) to allow the user to pull the vacuum cleaner (100) to the desired location. Since there is no cable attached to the wall, the user has no range limitation for the cleaning area. As can be seen in FIG. 3a, the auxiliary roller (151) is configured to be located under the first type cyclone (30).

Said main body (10) can also serve as a storage for spare accessories. The dust removed from the floor is collected in the suction unit (20). In several preferred embodiments of the invention, at least one battery housing (14) is formed in the main body (10) in which an auxiliary battery (221) suitable for use in the suction unit (20) can be placed and charged. This battery housing (14) is in the form of an opening extending inwards on the main body (10) and is easily accessible by the user. In a different embodiment of the invention, the number of the battery housings (14) can be increased. Auxiliary batteries (221) suitable for use in the suction unit (20) are charged in the battery housing (14). Advantageously, the invention allows both the battery (22) on the suction unit (20) and the auxiliary battery (221) on the main body (10) to be charged simultaneously when plugged into the charger with the adapter (50). This gives the user an advantage in terms of time.

In a preferred embodiment of the invention, the battery (22) on the suction unit (20) and the auxiliary battery (221) on the main body (10) can be charged sequentially. When the suction unit (20) is seated into the main body (10), the battery (22) of the suction unit (20) starts filling up first, and when it is filled, the auxiliary battery (221) starts filling up. When the suction unit (20) is not attached to the main body (10), or when it is removed from the main body (10), the auxiliary battery (221) starts charging, or if it is charging, the process continues. If the suction unit (20) is inserted into the main body (10) during the charging of the auxiliary battery (221), the charging of the auxiliary battery (221) is paused and the battery (22) in the suction unit (20) starts charging. In this embodiment of the invention, the charging of the battery (22) in the suction unit (20) is prioritized, whereas, in a different embodiment of the invention, both the battery (20) and the auxiliary battery (221) can be charged at the same time.

Referring to FIGS. 14a-c, a sixth type embodiment of the invention is provided, wherein the same suction unit (20) is positioned in the main body (10) in communication with the air inlet channel (12) in the main body (10). In this sixth type embodiment, no cyclone is provided, but the dust bag (60) is used for filtration. Said dust bag (60) is provided with a dust inlet nozzle (61) and, as can be best seen in FIG. 14b, the corresponding dust inlet nozzle (61) is positioned to face the main body inlet port (17). The air drawn in by the suction unit (20) passes through the main body inlet port (17) and then into this dust bag (60), where the relevant dust is first filtered. In the next stage, the filtered air passes into the suction unit (20). This ensures that the reservoir in the suction unit (20) is used for a longer period of time and is filled up at a later time. As can be seen in FIG. 14c, a dust bag cover (62) may be provided immediately above the dust bag (60) as part of the main body (10). This dust bag cover (62) allows easy access to the dust bag (60) and easy replacement thereof when it is full.

In the seventh type embodiment of the invention, the main body (10) has the blocking member (70) attached under the placement housing (11) as can be seen in FIG. 15. The blocking member (70) is configured to engage with the suction unit (20), so as to allow the suction unit (20) to be lifted perpendicularly with respect to the longitudinal axis of the main body (X). Moreover, the blocking member (70) has at least two oppositely arranged support members (73) for attaching and allowing the pivotal movement of the blocking member (70).

The blocking member (70) has a generally rectangular cross-section with an abutment protrusion (72) formed at one end, and at least one engagement tip (71) formed at the opposite other end for engaging with corresponding engagement hole(s) (241) formed on the suction unit (20). The engagement tips (71) have a substantially L-shaped cross-section with a flattened top portion.

Referring to FIGS. 16a and 16b, the blocking member (70) has a first position in which the abutment protrusion (72) extends towards the placement housing (11), and a second position in which the suction unit (20), when inserted into the placement housing (11), is partially pivotally moved and at least two engagement tips (71) of the blocking member (70) are thereby raised and engaged with the engagement holes (241) in the suction unit (20). This allows the user to carry the vacuum cleaner (100) without any problems by holding only the suction unit (20). When the user wants the remove the suction unit (20), the user pulls the suction unit (20) backward in the placement housing (11), in some embodiments optionally pressing the latch (18) before, the engagement hole(s) (241) and the engagement tip(s) (71) are no longer mated with each other and the suction unit (20) can be easily removed.

The placement housing (11) in both the fourth type and the fifth and sixth type vacuum cleaners can also be arranged to have a bottom at different angles. For example, it can have a flat bottom as in FIG. 4c, or the suction unit (20) can be positioned vertically as in FIG. 6b. The suction unit (20) of the invention can be used in all embodiments with the same characteristics.

1.-23. (canceled)

24. A vacuum cleaner comprising:
a main body to which a vacuum cleaner hose can be attached, and which has movable rollers; and
a suction unit having a motor for drawing air, a filter for filtering the drawn air and at least one battery, characterized in that said vacuum cleaner further comprises:
a placement housing in the main body arranged for placing the suction unit;
the suction unit which, according to the user's desire, can be utilized in a vertical position in which it is removed from the main body, or in a horizontal position in which it is placed in the placement housing in the main body; and
an air inlet channel formed in the main body in such a way that a suction end of the suction unit can be received therein.

25. A vacuum cleaner according to claim 24, comprising an air inlet channel which is arranged to open into a placement housing in the main body and is shaped and dimensioned in accordance with the suction end.

26. A vacuum cleaner according to claim 25, comprising at least one battery housing (14) formed in the main body, in which an auxiliary battery configured for use in the suction unit can be placed and charged.

27. A vacuum cleaner according to claim 24, comprising a first type cyclone which is removably inserted in a first type cyclone housing in the main body.

28. A vacuum cleaner according to claim 27, wherein the first type cyclone comprises an air inlet nozzle arranged for attaching the vacuum cleaner hose.

29. A vacuum cleaner according to claim 28, wherein the first type cyclone comprises a first cyclone zone into which air from the air inlet nozzle is first received, and a second cyclone zone into which air coming from the first cyclone zone reaches.

30. A vacuum cleaner according to claim 24, wherein the placement housing comprises a bottom inclined with respect to the longitudinal axis of the main body (X).

31. A vacuum cleaner according to claim 24, wherein the placement housing comprises a bottom extending parallel with respect to the longitudinal axis of the main body (X).

32. A vacuum cleaner according to claim 24, wherein the suction unit comprises the placement housing which allows the suction unit to be positioned vertically with respect to the longitudinal axis of the vacuum cleaner.

33. A vacuum cleaner according to claim 26, wherein the main body comprises a main body inlet port arranged for attaching the vacuum cleaner hose and opening into the air inlet channel in the main body.

34. A vacuum cleaner according to claim 33, comprising a lock mechanism for locking the suction unit once placed in the placement housing having an inclined bottom, and a latch arranged on the main body for releasing the suction unit from the lock mechanism.

35. A vacuum cleaner according to claim 33, comprising a charge connector (16) to be coupled with an opposing connector on the suction unit so that an electrical connection is established when the suction unit is placed in the placement housing.

36. A vacuum cleaner according to claim 26, comprising a second type cyclone which is removably inserted in a second type cyclone housing in the main body.

37. A vacuum cleaner according to claim 36, comprising a cyclone air inlet opening through which air from the main body inlet port on the main body passes into the second type cyclone.

38. A vacuum cleaner according to claim 37, comprising an air cyclone air inlet opening through which air is received into a reservoir in the second type cyclone, and a ramp on which air rises after it is passed through the inlet opening, and a mono cyclone suction duct which air reaches after the ramp.

39. A vacuum cleaner according to claim 36, wherein the second type cyclone comprises a reservoir handle configured for being held by a user.

40. A vacuum cleaner according to claim 24, wherein the main body has a blocking member attached under the placement housing and configured to engage with the suction unit, so as to allow the vacuum cleaner to be lifted perpendicularly with respect to the longitudinal axis of the main body (X).

41. A vacuum cleaner according to claim 40, wherein the blocking member has at least two oppositely arranged support members for attaching and allowing the pivotal movement of the blocking member in the placement housing.

42. A vacuum cleaner according to claim 40, wherein the blocking member has an abutment protrusion formed at one end, and at least one engagement tip formed at the opposite other end for engaging with corresponding engagement hole(s) formed on the suction unit.

43. A vacuum cleaner according to claim 42, wherein the blocking member has a first position in which the abutment protrusion extends towards the placement housing, and a second position in which the suction unit, when inserted into the placement housing, is partially moved and at least two engagement tips of the blocking member are thereby raised and engaged with the engagement holes in the suction unit.
